(19) United States
(12) Patent Application Publication
(10) Pub. No.: US 2012/0199578 A1
(43) Pub. Date: Aug. 9, 2012

(54) METHOD FOR ADJUSTING A HEATING POWER OUTPUT OF AN INDUCTION HEATING APPLIANCE AND CORRESPONDING INDUCTION HEATING APPLIANCE

(75) Inventor: Steffen Lang, Oberderdingen (DE)

(73) Assignee: E.G.O. ELEKTRO-GERATEBAU GMBH, Oberderdingen (DE)

(21) Appl. No.: 13/498,122

(22) PCT Filed: Sep. 22, 2010
(86) PCT No.: PCT/EP2010/063948

§ 371 Date: Apr. 24, 2012

(30) Foreign Application Priority Data
Sep. 24, 2009 (DE) 10 2009 048 490.6

(51) Int. Cl. H05B 6/06

(52) U.S. Cl. 219/660

(57) ABSTRACT

An induction heating device having an adjustable heating power output includes at least one resonant circuit, which includes an induction heating coil, and a heating power adjusting device, which is designed to vary a resonant frequency of the resonant circuit in order to adjust the heating power output.

### CROSS-REFERENCE TO RELATED APPLICATIONS

This application is a national stage application, filed under 35 U.S.C. §371, of International Application No. PCT/EP2010/063948, filed Sep. 22, 2010, which in turn claims priority to German Application No. 10 2009 048 490.6, filed Sep. 24, 2009, the contents of all of which are incorporated by reference.

### BRIEF SUMMARY

The invention relates to a method for adjusting a heating power output of an induction heating device, and to an associated induction heating device.

### BACKGROUND

In induction heating devices, an induction heating coil produces a magnetic alternating field which induces eddy currents in a cooking vessel which is to be heated and has a base composed of ferromagnetic material, causing demagnetization losses, thus heating the cooking vessel.

The induction heating coil is a component of a resonant circuit which comprises the induction heating coil and one or more capacitors. The induction heating coil is normally in the form of a flat, spirally wound coil with associated ferrite cores and is arranged, for example, under a glass ceramic surface of an induction cooking hob. In conjunction with the saucepan to be heated, the induction heating coil in this case forms an inductive and resistive part of the resonant circuit.

In order to control or to excite the resonant circuit, a low-frequency mains AC voltage at a mains frequency of 50 Hz or 60 Hz is first of all rectified, and is then converted to an excitation signal at a higher frequency, by means of semiconductor switches. Normally, the excitation signal is a square-wave voltage at a frequency in a range from 20 kHz to 50 kHz. A circuit for producing the excitation signal is also referred to as a (frequency) converter.

Various methods are known for adjusting a heating power output of the induction heating device.

In a first method, a frequency of the excitation signal or of the square-wave voltage is varied as a function of the heating power to be output or of the desired power consumption. This method for adjusting the heating power output makes use of the fact that, when the resonant circuit is excited at its resonant frequency, this results in a maximum heating power output. The greater the difference between the frequency of the excitation signal and the resonant frequency of the resonant circuit, the lower is the heating power output.

However, if the induction heating device has a plurality of resonant circuits, for example if the induction heating device forms an induction cooking hob with various induction cooking points, and different heating powers are set for the resonant circuits, beat frequencies can be caused by heterodyning of the different frequencies of the excitation signals, and this can lead to disturbance noise.

One method for heating power adjustment which avoids disturbance noise caused by such beat frequencies is pulse-width modulation of the excitation signal at a constant exciter frequency, at which a root mean square value of a heating power is set by varying the pulse width of the excitation signal. However, such root-mean-square value control by variation of the pulse width at a constant exciter frequency results in high switching-on and switching-off currents in the semiconductor switches, thus resulting in a broadband, high-energy interference spectrum.

DE 26 11 489 A1 and EP 0 188 980 B1 each disclose induction heating devices with an adjustable heating power output, in which an effective inductance of a transductor is varied in order to adjust the heating power output. The induction heating coil and the transductor are components that are separate from one another and form an inductive voltage divider, whose division ratio is varied in order to adjust the heating power output.

The invention is based on the object of providing a method for adjusting a heating power output of an induction heating device, as well as an associated induction heating device, which allow reliable adjustment of a heating power output with a comparatively small interference spectrum and with no or reduced disturbance noise.

The invention achieves this object by a method having the features of an induction heating device.

Preferred embodiments are the subject matter of the dependent claims, whose wording is hereby included by reference in the subject matter of the description, in order to avoid unnecessary repetition.

In the method according to the invention, a heating power output or heating power of an induction heating device which comprises at least one resonant circuit having an induction heating coil is adjusted by varying a resonant frequency of the at least one resonant circuit. The variation of the resonant frequency of the resonant circuit results in a difference between the resonant frequency and the frequency of the excitation signal being varied while the frequency of an excitation signal for the resonant circuit remains constant, thus varying the heating power output. If the resonant frequency is varied in the direction of the excitation frequency, that is to say the frequency difference is reduced, the heating power output increases, otherwise it decreases.

The resonant frequency of the resonant circuit is varied by varying an inductive component of the induction heating coil or of the resonant circuit. The induction heating coil therefore forms a transductor. A transductor is in general an electronic component whose effective inductance can be varied by means of a control signal. The transductor or the induction heating coil is controlled by means of a control current, in order to vary its inductance.

In one development, a periodic excitation signal whose frequency is constant is applied to the resonant circuit. By way of example, the constant frequency may be chosen from a frequency range from 20 kHz to 50 kHz. Preferably, the excitation signal is a square-wave voltage signal whose duty cycle is constant. The heating power output or heating power is for this situation adjusted exclusively by a suitable variation of the resonant frequency of the resonant circuit.

The induction heating device according to the invention having an adjustable heating power output comprises at least one resonant circuit, which comprises an induction heating coil. According to the invention, a heating power adjusting device is provided which is designed to vary a resonant frequency of the resonant circuit in order to adjust a heating power output, by varying an inductive component of the induction heating coil by means of a control current.

The induction heating coil preferably forms a transductor, which is controlled by means of the control current in order to vary its inductance. A ferrite core, which is associated with the induction heating coil, is preferably provided for field guidance, and control windings are arranged on it, with the control signal being applied to the control windings, in order to adjust the inductance of the transductor.

In one development, the induction heating device comprises a (frequency) converter, which is designed to apply a periodic excitation signal, whose frequency and/or duty cycle are/is constant, to the resonant circuit.

In one development, the induction heating device comprises a plurality of resonant circuits which each comprise an associated induction heating coil, with the heating power adjusting device being designed to vary a resonant frequency of the respective resonant circuit in order to adjust the heating power output of a respective resonant circuit, with excitation signals at an identical frequency and/or identical duty cycle being applied to each of the resonant circuits. This effectively prevents disturbance noise caused by heterodyning of the respective excitation signals.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a view from underneath of an induction heating coil whose effective inductance is controllable and

FIG. 2 shows an outline circuit diagram of an induction heating device having the induction heating coil illustrated in FIG. 1.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

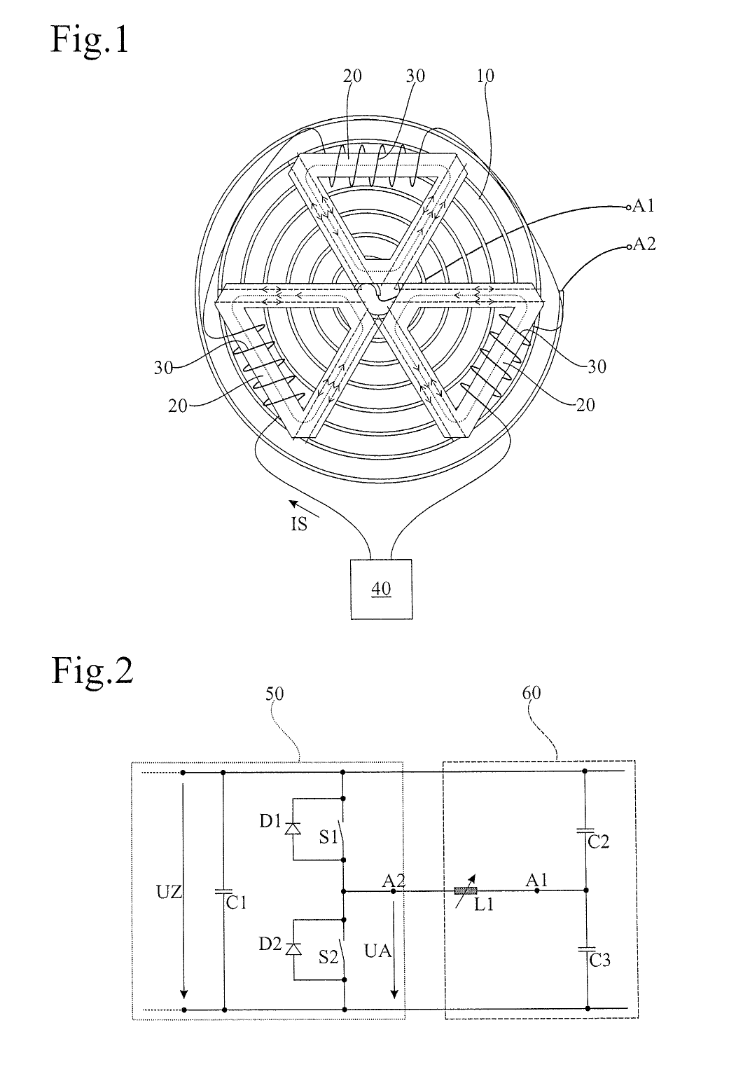

FIG. 1 shows a view from underneath of an induction heating coil whose effective inductance is controllable. The illustrated induction heating coil comprises a planar, flat, spirally wound main winding 10 having connections A1 and A2, ferrite cores 20 arranged under the main winding 10 for field guidance and on which control windings 30 are arranged, and a control signal production device 40, which produces a control current IS which is applied to the control windings 30. The induction heating coil is part of a resonant circuit, which will be described in more detail in the following text with reference to FIG. 2.

The induction heating coil illustrated in FIG. 1 forms a transductor, that is to say an electronic component whose effective inductance is controllable or adjustable by means of the control current IS. A variation in the effective inductance of the induction heating coil results in a variation of a resonant frequency of the resonant circuit which contains the induction heating coil, thus likewise varying a heating power output of the induction heating device.

The control signal or the control current IS varies a magnetic permittivity of the ferrite cores 20, thus varying an effective inductance of the induction heating coil or of the transductor. Heterodyning in the same sense of the magnetic control field produced by the control current IS with the magnetic field produced by the main winding 10 leads to magnetic saturation of the ferrite cores 20, and therefore to a major reduction in the effective inductance of the induction heating coil. Heterodyning of said fields in the same sense results in compensation, and therefore in maintenance of or a slight increase in the effective inductance of the induction heating coil.

The described, advantageous arrangement of the control windings 30 prevents the field produced by the main winding 10 inducing a voltage in the control windings 30, thus allowing the control signal production device 40 to be designed in a simple form.

The induction heating coil illustrated in FIG. 1 may be arranged underneath a glass ceramic surface of an induction cooking hob, which is not illustrated, in which case the induction cooking hob may have a plurality of cooking points, each of which may have one or more associated induction heating coils such as these.

FIG. 2 shows an outline circuit diagram of an induction heating device which comprises the induction heating coil illustrated in FIG. 1. The induction heating coil illustrated in FIG. 1 is represented in FIG. 2 by its electrical equivalent circuit in the form of a variable inductance L1.

The induction heating device comprises a conventional converter 50, which uses a mains AC voltage to first of all produce a rectified intermediate-circuit voltage UZ, which is buffered by means of an intermediate-circuit capacitor C1, with semiconductor switches S1 and S2 and associated freewheeling diodes D1 and D2 producing a high-frequency excitation signal in the form of a square-wave excitation voltage UA at a constant frequency and with a constant duty ratio.

The excitation voltage UA is used to excite a resonant circuit 60, which comprises the induction heating coil L1 and capacitors C2 and C3, which are connected in the illustrated manner. The capacitors C2 and C3 are connected in series between the intermediate-circuit voltage UZ, with a connecting node of the capacitors C2 and C3 being connected to the connection A1 of the main winding 10 or of the induction heating coil L1. The connection A2 of the main winding 10 or of the induction heating coil L1 is connected to a connecting node of the semiconductor switches S1 and S2, and the excitation voltage UA is applied thereto.

The induction heating coil L1 varies its effective inductance as a function of the control current IS, and in consequence forms a transductor. The heating power output to a ferromagnetic cooking vessel, which is not illustrated, depends on the difference between the frequency of the excitation voltage UA and the resonant frequency of the resonant circuit 60. The resonant frequency of the resonant circuit 60 in turn depends on the capacitances of the capacitors C2 and C3 and the effective inductance of the induction heating coil L1. The effective inductance of the induction heating coil L1 is governed not only by the control current IS but also by the magnetic characteristics of the saucepan to be heated.

FIG. 2 illustrates only one resonant circuit 60. It is self-evident that further resonant circuits, which are not shown, may be provided, and may be implemented in a corresponding manner.

The induction heating device may be a component of an induction cooking hob having a plurality of induction cooking points.

A capacitance of the capacitor C1 and/or C2 may also be varied, in addition to or as an alternative to variation of the effective inductance of the induction heating coil L1, in order to vary the resonant frequency of the resonant circuit 60.

If required, the frequency of the excitation voltage UA may be switched between different frequency values in order to shape an interference spectrum. However, this is not used for heating power adjustment. For this situation, it may be necessary to suitably readjust the resonant frequency of the resonant circuit 60 by variation of the control current IS.

The illustrated embodiments make it possible to adjust a heating power output with a comparatively small interference spectrum and with no or reduced disturbance noise.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for adjusting a heating power output of an induction heating device which comprises at least one resonant circuit having an induction heating coil, wherein
in order to adjust the heating power, a resonant frequency of the at least one resonant circuit is varied by varying an inductive component of the induction heating coil by means of a control current.

2. The method as claimed in claim 1, wherein a periodic excitation signal whose frequency is constant is applied to the resonant circuit.

3. The method as claimed in claim 1, wherein the excitation signal is a square-wave voltage signal whose duty cycle is constant.

4. The method as claimed in claim 1, wherein the induction heating coil forms a transductor, which is controlled by means of the control current in order to vary its inductance.

5. An induction heating device having an adjustable heating power output, having:
at least one resonant circuit, which comprises an induction heating coil: and
a heating power adjusting device, which is designed to vary a resonant frequency of the at least one resonant circuit for heating power adjustment, by varying an inductive component of the induction heating coil by means of a control current.

6. The induction heating device as claimed in claim 5, wherein the induction heating coil forms a transductor, which is controlled by means of the control current in order to vary its inductance.

7. The induction heating device as claimed in claim 6, comprising:
a ferrite core, which is associated with the induction heating coil and on which control windings are arranged, with the control signal being applied to the control windings in order to adjust the inductance of the transductor.

8. The induction heating device as claimed in claims 5, comprising a converter, which is designed to apply a periodic excitation signal, whose frequency is constant, to the resonant circuit.

9. The induction heating device as claimed in claim 5, wherein a plurality of resonant circuits are provided and each comprise an induction heating coil, with the heating power adjusting device being designed to vary a resonant frequency of the respective resonant circuit in order to adjust the heating power output, with excitation signals at an identical frequency being applied to each of the resonant circuits.
